(19) United States
(12) Patent Application Publication
(10) Pub. No.: US 2026/0103004 A1
(43) Pub. Date: Apr. 16, 2026

(54) LIQUID SUPPLY DEVICE AND LIQUID EJECTION APPARATUS

(71) Applicant: CANON KABUSHIKI KAISHA, Tokyo (JP)

(72) Inventors: MITSURU CHIDA, Kanagawa (JP); JUNICHIRO IRI, Kanagawa (JP)

(21) Appl. No.: 19/331,859

(22) Filed: Sep. 17, 2025

(30) Foreign Application Priority Data
Oct. 10, 2024 (JP) 2024-177670

(51) Int. Cl. B41J 2/175; B41J 2/17

(52) U.S. Cl. CPC B41J 2/17513; B41J 2/1707; B41J 2/17553; B41J 2/17556; B41J 2002/17516

(57) ABSTRACT

A liquid supply device, configured to supply a liquid from a liquid storage container having a storage portion and a supply portion, includes: a support portion having a first end portion, a second end portion, and a placement surface; an injection portion, to which the supply portion is connected; a pressing member; and a control portion configured to execute a supply operation for supplying liquid by controlling an action of the pressing member. In a state in which the supply portion is connected to the injection portion, the storage portion is placed on the placement surface. In the supply operation, the control portion causes the pressing member to move in a direction from the first end portion toward the second end portion in a state in which the pressing member is pressing the storage portion.

### BACKGROUND

### Field of the Technology

The present disclosure relates to a liquid supply device, and to a liquid ejection apparatus including a liquid supply device.

### Description of the Related Art

Liquid ejection apparatuses such as ink jet printers are provided with liquid ejection heads that eject liquid toward a recording medium. Several methods for supplying a liquid such as ink to a liquid ejection head are known, including a method in which an ink cartridge is mounted on a carriage that supports the liquid ejection head and the ink cartridge supplies the liquid, a method in which a liquid storage portion such as an ink tank is separately provided and liquid is supplied to the head using a pump or the like, and others.

To reduce recording costs, handle high-volume printing, and the like, in recent years, a configuration has become mainstream in which a high-capacity ink tank is provided in the main body of the liquid ejection apparatus, a liquid storage container that stores a liquid is connected to the apparatus main body, and an ink tank is refilled with the liquid from the liquid storage container. As a cartridge case supporting a liquid storage container having a liquid storage bag that stores a liquid, Japanese Patent Application Publication No. 2015-196299 discloses a configuration that enables the liquid to be supplied to the apparatus main body by using a shaft part to roll up the liquid storage bag in the direction of a plug.

In this configuration, the liquid storage bag is rolled up as the liquid is supplied, and the liquid storage bag therefore bulges inside the case as the supply of liquid progresses. In particular, a liquid storage bag having a larger capacity (a larger size) will occupy a greater volume inside the case, and more space is required. Conversely, reducing the volume of the liquid storage bag to save space increases the frequency with which the liquid storage bag needs to be replaced, which is burdensome. Furthermore, it is necessary for a user to always keep a plurality of spare liquid storage bags on hand, which is not only unsuitable for liquid ejection apparatuses required to print in large volumes, but is also considered problematic from an ecological perspective.

### SUMMARY

Present disclosure is directed to provide a liquid supply device capable of efficiently supplying ink from within a liquid storage container through a different method.

According to some embodiments, a liquid supply device configured to supply a liquid from a liquid storage container, the liquid storage container having a storage portion that is flexible and that stores a liquid inside and a supply portion configured to supply the liquid stored inside the storage portion, the liquid supply device of the present disclosure is characterized by features including:
a support portion supporting the liquid storage container, the support portion having a first end portion, a second end portion on a side opposite from the first end portion, and a placement surface on which the storage portion can be placed;
an injection portion to which the supply portion is connected and into which the liquid stored in the storage portion is injected through the supply portion, the injection portion being provided in the second end portion of the support portion;
a pressing member configured to press the storage portion of the liquid storage container supported by the support portion; and
a control portion configured to execute a supply operation for supplying liquid by controlling an action of the pressing member,
wherein in a state in which the supply portion is connected to the injection portion, the storage portion is placed on the placement surface, and
wherein in the supply operation, the control portion causes the pressing member to move in a direction from the first end portion toward the second end portion in a state in which the pressing member is pressing the storage portion.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view of a pressing member, a support member, and an ink storage container, according to a first embodiment;

FIG. 1B is an explanatory diagram illustrating a pressing operation by the pressing member on the ink storage container, according to the first embodiment;

FIG. 2A is a perspective view of the pressing member, the support member, and the ink storage container, according to a second embodiment;

FIG. 2B is an explanatory diagram illustrating a pressing operation by the pressing member on the ink storage container, according to the second embodiment;

FIG. 3A is a perspective view of the pressing member, the support member, and the ink storage container, according to a third embodiment;

FIG. 3B is an explanatory diagram illustrating a pressing operation by the pressing member on the ink storage container, according to the third embodiment;

FIG. 4A is a perspective view of the pressing member, the support member, and the ink storage container, according to a fourth embodiment;

FIG. 4B is an explanatory diagram illustrating a pressing operation by the pressing member on the ink storage container, according to the fourth embodiment;

FIG. 5A is a perspective view of the pressing member, the support member, and the ink storage container, according to a fifth embodiment;

FIG. 5B is an explanatory diagram illustrating a pressing operation by the pressing member on the ink storage container, according to the fifth embodiment;

FIG. 6A is an exploded perspective view of the support member and the ink storage container.

FIG. 6B is a perspective view illustrating a state in which the ink storage container is supported by the support member.

FIG. 6C is a perspective view illustrating the liquid supply device with the support member removed from the main body portion.

FIG. 6D is a perspective view illustrating the liquid supply device in a state where the support member is attached to the main body portion.

FIG. 7A illustrates a state in which the pressing member is in a standby position;

FIG. 7B illustrates a state in which the pressing member is in a first pressing position below the standby position.

FIG. 7C illustrates a state in which the pressing member has moved from the first pressing position toward the second end portion but has not yet reached the second end portion

FIG. 7D illustrates a state in which the pressing member has moved further toward the second end portion and is in a second pressing position

FIG. 7E illustrates a state in which the pressing member is in a retracted position above the second pressing position.

FIG. 7F illustrates a state in which the pressing member has moved from the retracted position toward the first end portion and is in a standby position; and

FIG. 8 is a schematic diagram illustrating the overall configuration of a liquid ejection apparatus according to the first embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments. In addition, not all features described in the following embodiments are essential to solutions provided by the invention.

Hereinafter, embodiments will be described in which the present disclosure is applied to a liquid supply device for supplying ink from a liquid storage container to an ink jet recording head (a liquid ejection head) and an ink jet recording apparatus (a liquid ejection apparatus) that eject ink as a liquid. However, it is to be understood that the present disclosure is not limited to these examples. For example, the present disclosure can be applied in liquid supply devices that supply liquid to apparatuses such as printers, copiers, fax machines having communication systems, word processors having printer units, and the like, and furthermore to industrial recording apparatuses that combine a variety of processing apparatuses.

### First Embodiment

A liquid ejection apparatus 100 that records images by ejecting ink as a recording liquid onto a recording medium P such as paper or a sheet, and a liquid supply device 40 for supplying ink (a liquid) to the liquid ejection apparatus 100, will be described as a first embodiment.

### Liquid Ejection Apparatus

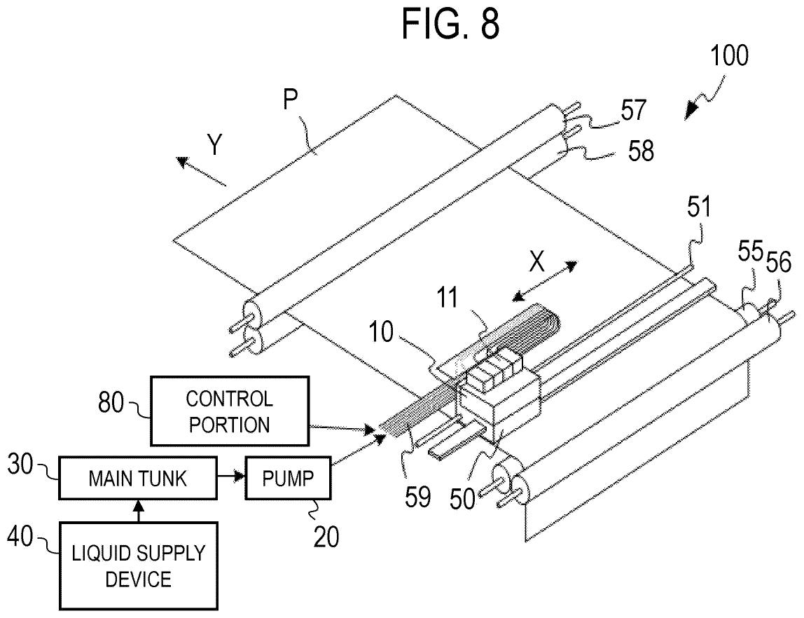

FIG. 8 is a schematic diagram illustrating the overall configuration of the liquid ejection apparatus 100 according to the first embodiment. FIG. 8 mainly illustrates the overall configuration of a liquid ejection portion (a recording portion) of the liquid ejection apparatus 100. The liquid ejection apparatus 100 of the present embodiment is a serial scanning-type ink jet recording apparatus that records an image onto the recording medium P by ejecting ink from a liquid ejection head 10.

The liquid ejection apparatus 100 includes the liquid ejection head 10, a pump 20, a main tank 30, the liquid supply device 40, a carriage 50, and a control portion 80. The liquid ejection head 10 is mounted on the carriage 50, and the carriage 50 moves in a main scanning direction X along a guide shaft 51. In other words, the liquid ejection head 10 is configured to be capable of scanning (moving) in the main scanning direction X relative to the apparatus main body of the liquid ejection apparatus 100.

The liquid ejection apparatus 100 is equipped with a conveyance portion that conveys the recording medium P in a sub-scanning direction Y, which intersects with the main scanning direction X. The conveyance portion is constituted by conveyance members, such as conveyance rollers 55, 56, 57, and 58, which convey the recording medium P. In the present embodiment, the main scanning direction X (the movement direction of the liquid ejection head 10) and the sub-scanning direction Y (the conveyance direction of the recording medium P) are orthogonal to each other.

A plurality of sub-tanks 11 are mounted in the liquid ejection head 10, and ink is supplied for each type of ink. Electrical wiring, as well as tubes for ink and air, which are necessary for printing (recording), are connected to a carriage 53 by a guide 59. Each sub-tank 11 stores a different color of ink, and the liquid ejection head 10 is configured to be capable of high-quality full-color printing using a plurality of color inks. In the first embodiment, the liquid ejection apparatus 100 is provided with four sub-tanks 11 corresponding to respective ones of four colors of ink (black, yellow, cyan, and magenta).

The main tank 30 is a liquid storage portion that stores ink inside. The ink held in the main tank 30 is supplied to the sub-tank 11 by the pump 20. In the first embodiment, the liquid ejection apparatus 100 is provided with four main tanks 30 corresponding to respective ones of four colors of ink. Each main tank 30 is connected to the sub-tank 11 corresponding to the same color, and ink is supplied from the main tank 30 to the sub-tank 11. In other words, in the first embodiment, the main tanks 30 mounted in the apparatus main body of the liquid ejection apparatus 100 and the sub-tanks 11 mounted to the liquid ejection head 10 are provided as two types of ink tanks (liquid storage portions).

The liquid supply device 40 is a liquid supply unit for supplying the liquid contained in the liquid storage container to the liquid ejection apparatus 100 (in this example, the main tank 30). The liquid supply device 40 is configured to be removable from the liquid storage container. When the ink held within a given liquid storage container is exhausted, a user can attach a new liquid storage container (which is filled with ink) to the liquid supply device 40 to continue supplying ink to the liquid ejection apparatus 100.

Various operations such as recording operations (printing operations) by the liquid ejection head 10 and supply operations by the liquid supply device 40 are executed and controlled by the control portion 80. The control portion 80 can be configured by a processor, memory, storage, and the like, for example. In this case, the functions of the control portion 80 are implemented by the processor executing programs stored in the memory or storage. In the first embodiment, the control portion 80 of the liquid ejection apparatus 100 controls the operations of the liquid ejection head 10 and the liquid supply device 40, but the configuration is not limited thereto. For example, the configuration may be such that a dedicated control portion is provided in the liquid supply device 40 to control the operations of the liquid supply device 40.

### Liquid Supply Apparatus

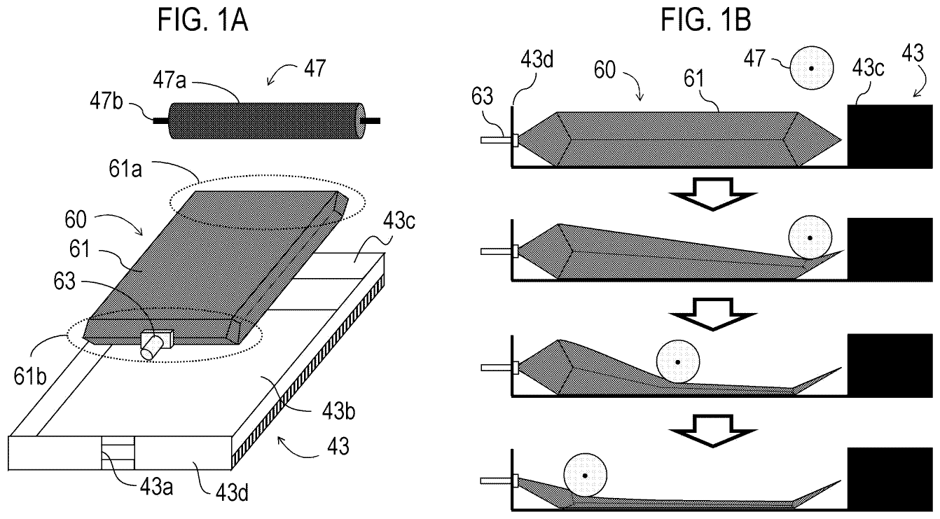

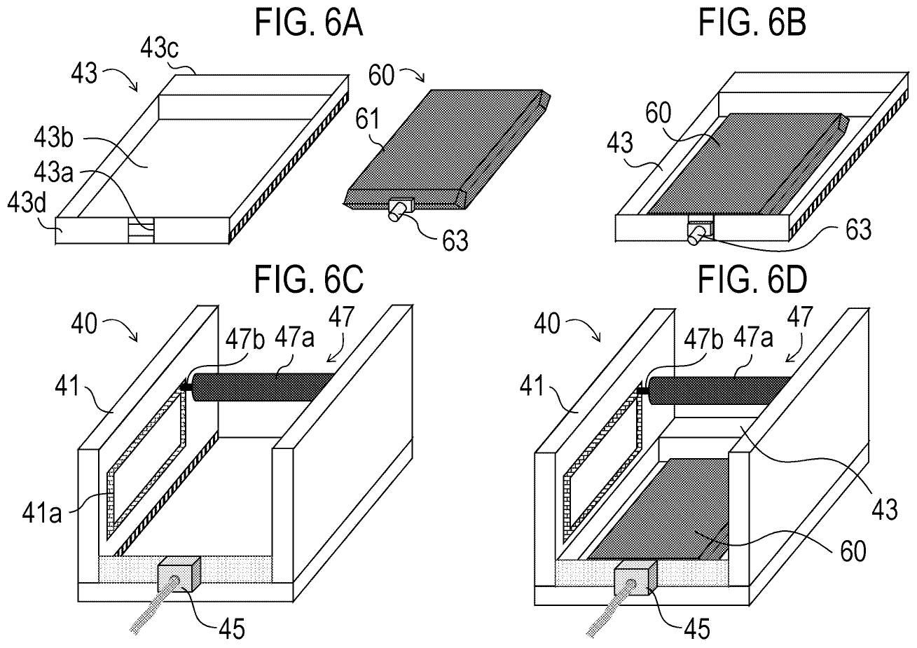

The liquid supply device 40, and an ink storage container 60 capable of being removed from the liquid supply device 40, will be described in more detail. FIGS. 1A and 1B are explanatory diagrams illustrating a support member 43 and a pressing member 47 provided in the liquid supply device 40, as well as the ink storage container 60, according to the first embodiment. FIGS. 6A to 6D are explanatory diagrams illustrating the liquid supply device 40 according to the first embodiment.

The liquid supply device 40 includes a main body portion 41; the support member 43, which constitutes a support portion that supports the ink storage container 60; an injection portion 45 to which the ink storage container 60 is connected and into which ink is injected; and the pressing member 47 for pressing the ink storage container 60. The support member 43 is configured to be removable from the main body portion 41.

The ink storage container 60 is a liquid storage container that stores ink as a liquid to be supplied to the liquid ejection apparatus 100. The ink storage container 60 includes a storage portion 61 that is flexible and that stores ink inside, and a supply portion 63 for supplying the ink held in the storage portion 61 to the liquid ejection apparatus 100.

FIG. 1A is a perspective view of the pressing member 47, the support member 43, and the ink storage container 60. FIG. 1B is an explanatory diagram illustrating a pressing operation by the pressing member 47 on the ink storage container 60. FIG. 6A is an exploded perspective view of the support member 43 and the ink storage container 60. FIG. 6B is a perspective view illustrating a state in which the ink storage container 60 is supported by the support member 43. FIG. 6C is a perspective view illustrating the liquid supply device 40 with the support member 43 removed from the main body portion 41. FIG. 6D is a perspective view illustrating the liquid supply device 40 in a state where the support member 43 is attached to the main body portion 41.

The storage portion 61 of the ink storage container 60 is formed by a sheet member, made from a film, being folded and welded. In other words, the outer peripheral portion of the storage portion 61 includes a folded portion where the sheet member is folded, and a welded portion for sealing the storage portion 61. When the ink storage container 60 is not in use, the interior of the storage portion 61 is filled with ink for supply to the main tank 30 of the liquid ejection apparatus 100. The ink storage container 60 is a flattened container that increases in thickness as the interior thereof is filled with ink, and has an approximately rectangular shape when viewed in a thickness direction. However, the ink storage container 60 is not limited to such a shape. For example, the shape may be approximately square when viewed in the thickness direction, or may be another polygonal shape, elliptical shape, or the like.

The supply portion 63 is provided at one end portion, in the longitudinal direction, of the substantially rectangular shape of the storage portion 61, and includes a feeding port through which ink can pass. The supply portion 63 is a member that can be formed from a plastic material or the like, for example. In this example, the supply portion 63 is disposed at one end portion in the longitudinal direction and in the center in a widthwise direction, but the configuration is not limited thereto. For example, the supply portion 63 may be provided at an end portion in the widthwise direction, or may be provided at a corner portion.

The ink storage container 60 in which the interior of the storage portion 61 is filled with ink is mounted on the support member 43 with the supply portion 63 fixed thereto. A fixing portion 43a, which is open for fixing the supply portion 63, is provided at one end portion of the support member 43 in the longitudinal direction thereof. A placement surface 43b on which the ink storage container 60 is placed is formed in the support member 43, between one end portion and the other end portion in the longitudinal direction. When the supply portion 63 is fixed to the fixing portion 43a, the storage portion 61 is placed on the placement surface 43b of the support member 43. At this time, the ink storage container 60 is supported such that the feeding port of the supply portion 63 protrudes to the outer side of the support member 43. In the first embodiment, the placement surface 43b is a horizontal surface, and the ink storage container 60 is placed on the placement surface 43b such that the thickness direction thereof is parallel to the direction of gravity.

The support member 43 is a support portion in which a space for accommodating the ink storage container 60, the fixing portion 43a, and the like are formed, and is configured such that the ink storage container 60 can be accommodated therein while the storage portion 61 is placed on the placement surface 43b. The support member 43 is a drawer configured to be insertable and removable from the main body portion 41 of the liquid supply device 40. In the following descriptions, with respect to a longitudinal direction that is parallel to the insertion/removal direction of the support member 43, the end portion on the side where the fixing portion 43a of the support member 43 is not provided will be referred to as a first end portion 43c, and the end portion on the side opposite from the first end portion 43c, where the fixing portion 43a is provided, will be referred to as a second end portion 43d.

When the supply portion 63 is fixed to the fixing portion 43a, the support member 43 is inserted (mounted) to the main body portion 41, and the supply portion 63 is connected to the injection portion 45. The ink in the storage portion 61 can then be supplied to the main tank 30 of the liquid ejection apparatus 100 through the supply portion 63 and the injection portion 45.

In the first embodiment, the liquid ejection apparatus 100 is provided with four support members 43 corresponding to respective ones of four colors of ink (black, yellow, cyan, and magenta). The support member 43 supporting the ink storage container 60 corresponding to each color is then pushed into a corresponding insertion stage, which connects the supply portion 63 to the injection portion 45 and fixes the ink storage container 60 to the liquid supply device 40.

As illustrated in FIG. 6D, the pressing member 47 is positioned above the support member 43, the ink storage container 60 inserted into the main body portion 41, and the like. The pressing member 47 presses the ink storage container 60 supported by the support member 43 from above, which causes the ink stored in the storage portion 61 to be supplied to the outside. In other words, the pressing member 47 is disposed so as to press the surface of the storage portion 61 opposite from the surface that contacts the placement surface 43b.

The pressing member 47 according to the first embodiment is a roller configured to be rotatable. The pressing member 47 includes a cylindrical roller portion 47a, and a rotation shaft 47b extending from both ends of the roller portion 47a in a widthwise direction orthogonal to the longitudinal direction of the support members 43. The pressing member 47 is supported by the main body portion 41 so as to be capable of rotating about the rotation shaft 47b. The roller portion 47a is configured to be capable of pressing substantially the entire area of the ink storage container 60 supported by the support member 43 in the widthwise direction. Preferably, the roller portion 47a is formed from a material such as rubber or plastic to suppress damage to the ink storage container 60.

A rectangular opening 41a through which the rotation shaft 47b of the pressing member 47 is inserted is formed in the main body portion 41. The pressing member 47 is supported so as to be capable of moving along the opening 41a in a vertical direction and a longitudinal direction (the insertion/removal direction) of the support member 43.

As illustrated in FIG. 1B, the pressing member 47 moves in the direction from the first end portion 43c to the second end portion 43d of the support member 43 while pressing the storage portion 61 of the ink storage container 60 and rotating. The pressing member 47 moves from the first end portion 43c toward the second end portion 43d so as to press substantially the entire area of the storage portion 61, from one end portion 61a to an other end portion 61b in the longitudinal direction thereof. Supplying ink by flattening substantially the entire area of the storage portion 61 using the pressing member 47 makes it possible to suppress situations where ink remains inside the ink storage container 60.

The first embodiment describes a configuration in which the pressing member 47 moves toward the supply portion 63 while pressing the storage portion 61, which causes the ink inside to move toward the supply portion 63. However, the configuration may be such that a pump is provided in the liquid ejection apparatus 100 and the ink is sucked in at the same time. Such a configuration makes it possible not only for the pressing member 47 to press the ink out, but also facilitate the movement of the ink by suctioning the ink from the liquid ejection apparatus 100 side.

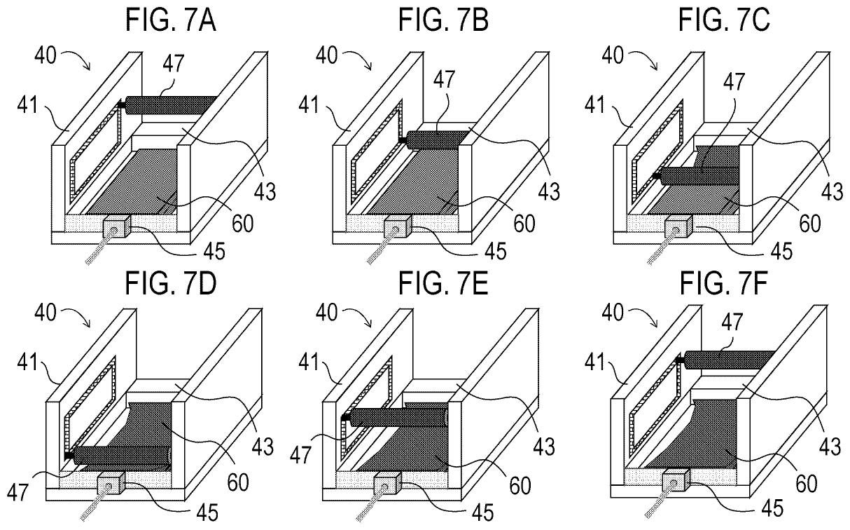

The ink supply operations by the liquid supply device 40 will be described in detail next. FIGS. 7A to 7F are explanatory diagrams illustrating the ink supply operations. In the first embodiment, the pressing member 47 moves along the longitudinal direction of the support member 43 while flattening the storage portion 61 of the ink storage container 60. At this time, the action of the pressing member 47 is controlled by the control portion 80.

FIG. 7A illustrates a state in which the pressing member 47 is in a standby position. The pressing member 47 is located in the standby position before the ink supply operations are started, when the support member 43 is removed from the main body portion 41, and the like. The standby position is a position on the first end portion 43c side of the support member 43 in the longitudinal direction, and is a position where the ink storage container 60 is retracted with respect to the direction of gravity.

FIG. 7B illustrates a state in which the pressing member 47 is in a first pressing position below the standby position. When the ink supply operations are started, the pressing member 47 moves downward in the direction of gravity from the standby position, toward the placement surface 43b. The pressing member 47 then presses the storage portion 61 from the first end portion 43c side thereof. In this manner, the first pressing position is a position where the pressing member 47 descends so as to press the storage portion 61, and is a position where the storage portion 61 is pressed on the first end portion 43c side.

The ink supply operations may be started, for example, by the user by operating an operation panel, or the configuration may be such that a detection portion that detects that the support member 43 supporting the ink storage container 60 has been attached to the main body portion 41 is provided and the ink supply operations are started automatically on the basis of a detection result from the detection portion. Alternatively, the configuration may be such that a detection portion that detects the amount of ink remaining in the main tank 30 is provided, and the ink supply operations are started when the remaining amount of ink falls below a predetermined amount.

FIG. 7C illustrates a state in which the pressing member 47 has moved from the first pressing position toward the second end portion 43d but has not yet reached the second end portion 43d. The control portion 80 determines the amount of ink to be supplied from the ink storage container 60, i.e., a movement distance by which to move the pressing member 47, in accordance with the amount of ink remaining in the main tank 30 of the liquid ejection apparatus 100. The pressing member 47 then moves toward the second end portion 43d while pressing the storage portion 61 and rotating, in accordance with the determined movement distance. This action of the pressing member 47 causes a desired amount of ink to be supplied from the ink storage container 60 to the main tank 30 through the supply portion 63, the injection portion 45, and the like.

The movement amount of the pressing member 47 in the ink supply operation may be determined as appropriate in accordance with the amount of ink remaining in the main tank 30 before the start of the ink supply operations, or the ink supply amount may be determined in advance so as to be constant. For example, the configuration may be such that the ink supply operations are started when the amount of ink remaining in the main tank 30 falls below a predetermined amount, and the movement amount of the pressing member 47 may be determined in advance so that the amount of ink supplied does not become excessive.

FIG. 7D illustrates a state in which the pressing member 47 has moved further toward the second end portion 43d and is in a second pressing position. When the ink supply operations are started again, the pressing member 47, which had been stopped, starts moving again. Then, when the pressing member 47 reaches the second end portion 43d, substantially the entire area of the storage portion 61 is pressed, and substantially no ink remains inside. In this manner, the position where the pressing member 47 presses the storage portion 61 on the second end portion 43d side is the second pressing position. The pressing member 47 reaching the second pressing position means that it is time for the ink storage container 60 to be replaced. Note that with respect to the direction of gravity, the first pressing position and the second pressing position are the same position. The ink supply operations at this time can also be started on the basis of a user operation, the amount of ink remaining in the main tank 30, or the like.

FIG. 7E illustrates a state in which the pressing member 47 is in a retracted position above the second pressing position. When the pressing member 47 reaches the second pressing position, the pressing member 47 moves upward, away from the ink storage container 60. The position of the pressing member 47 at this time, retracted from the position where the ink storage container 60 is pressed, is the retracted position.

FIG. 7F illustrates a state in which the pressing member 47 has moved from the retracted position toward the first end portion 43c and is in a standby position. The pressing member 47 then returns to the same position the pressing member 47 was in before the start of the ink supply operations. Note that with respect to the direction of gravity, the retracted position and the standby position are the same position. In addition, the distance from the retracted position to the standby position is the same as the distance from the first pressing position to the second pressing position. Note also that the liquid ejection apparatus 100 may be provided with a notification portion that makes a notification using images, audio, or the like when the ink storage container 60 is empty and it is time to replace the ink storage container 60. The configuration can be such that the user can be notified in response to the pressing member 47 reaching the retracted position, the standby position, or the like, for example.

As illustrated in FIGS. 7A to 7F, the ink supply operations for a single ink storage container 60 are completed by the pressing member 47 moving to the standby position, the first pressing position, the second pressing position, the retracted position, and the standby position in that order. By releasing the support member 43 from the main body portion 41 and replacing the ink storage container 60 from which the ink has been exhausted with a new ink storage container 60, the user can ensure that ink continues to be supplied to the liquid ejection apparatus 100 in a simple manner. Note that in this example, the range over which the pressing member 47 can be moved is set to the range from the first pressing position (the standby position) to the second pressing position (retracted position) with respect to the longitudinal direction, and from the first pressing position (the second pressing position) to the standby position (the retracted position) with respect to the direction of gravity. However, the configuration is not limited thereto, and the opening 41a and other members may be configured such that the pressing member 47 can be moved over a broader range.

Through the configuration described thus far, the ink supply operations can be performed by using the pressing member 47 to flatten substantially the entire area of the storage portion 61. This makes it possible to improve the ability to use up all the ink inside the ink storage container 60, and reduce situations where ink remains inside the ink storage container 60 and is wasted. Additionally, the pressing member 47 is configured to be capable of pressing substantially the entire area of the storage space formed in the support member 43, which makes it possible to handle ink storage containers 60 of different sizes and capacities. Furthermore, the ink storage container 60 does not bulge between before and after the ink supply operations, and thus only a minimum space for storage is required, even when using a large-capacity ink storage container 60. In other words, this configuration makes it possible to achieve the three Rs (Reduce, Reuse, Recycle) proposed in recent years. The technique described herein can contribute to the achievement of a sustainable society, such as a decarbonized/recycling-oriented society.

Note that the configurations described above as the first embodiment are merely examples, and each configuration can be changed as appropriate. For example, the support member 43 may be configured to not be removable from the main body portion 41, and the ink storage container 60 may be configured to be directly attached to the liquid supply device 40. Additionally, for example, instead of the support member 43, the entire liquid supply device 40 may be configured to be removable from the apparatus main body of the liquid ejection apparatus 100.

### Second Embodiment

A second embodiment will be described next. In the second embodiment, the configuration of the pressing member of the liquid supply device 40 is different from that in the first embodiment. Only the configurations of the second embodiment that are different from those in the first embodiment will be described hereinafter. Configurations that are the same in the second embodiment and the first embodiment will be given the same reference signs, and descriptions thereof will be omitted.

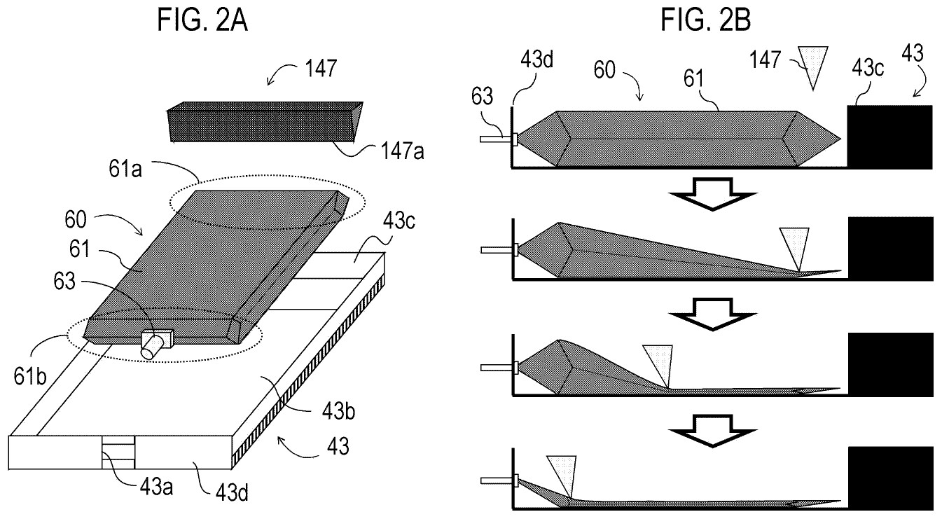

FIGS. 2A and 2B are explanatory diagrams illustrating the support member 43 and a pressing member 147 provided in the liquid supply device 40, as well as the ink storage container 60, according to the second embodiment. FIG. 2A is a perspective view of the pressing member 147, the support member 43, and the ink storage container 60. FIG. 2B is an explanatory diagram illustrating a pressing operation by the pressing member 147 on the ink storage container 60.

The pressing member 147 according to the second embodiment is formed in the form of a blade having a tip portion 147a that extends downward in the direction of gravity. In the ink supply operations, the storage portion 61 of the ink storage container 60 is pressed by the tip portion 147a of the pressing member 147.

With respect to the longitudinal direction of the support member 43, the tip portion 147a is configured such that the width thereof narrows with proximity to the end of the tip portion 147a. The end of the tip portion 147a may have a rounded shape or a chamfered shape, and a flat surface extending along the longitudinal direction of the support member 43 may be formed. In other words, the shape of the tip portion 147a can be changed according to the properties, material, and the like of the storage portion 61 to the extent that the tip portion 147a does not damage the storage portion 61.

As illustrated in FIG. 2B, in the second embodiment as well, the pressing member 147 moves in the direction from the first end portion 43c to the second end portion 43d of the support member 43 while pressing the storage portion 61 of the ink storage container 60. In other words, the pressing member 147 presses substantially the entire area of the storage portion 61, from one end portion 61a to the other end portion 61b in the longitudinal direction thereof.

Aside from the shape of the pressing member 147 and the fact that the pressing member 147 moves without rotating, the actions of the pressing member 147 in the ink supply operations are the same as those in the first embodiment, illustrated in FIGS. 7A to 7F. Detailed descriptions of the ink supply operations will therefore be omitted.

According to the configuration of the second embodiment as well, the ink supply operations can be performed by using the pressing member 147 to flatten substantially the entire area of the storage portion 61. This makes it possible to improve the ability to use up all the ink inside the ink storage container 60, and reduce situations where ink remains inside the ink storage container 60 and is wasted. Additionally, the pressing member 147 is configured to be capable of pressing substantially the entire area of the storage space formed in the support member 43, which makes it possible to handle ink storage containers 60 of different sizes.

In the second embodiment, the pressing member 147 can be moved to the retracted position, the standby position, and the like, which makes it possible to separate the pressing member 147 from the ink storage container 60. However, the configuration is not limited thereto. For example, the configuration may be such that the pressing member 147 is separated from the ink storage container 60 by changing the orientation of the pressing member 147 such that the tip portion 147a of the pressing member 147 faces in the horizontal direction, rather than downward. Such a configuration contributes to saving space in the direction of gravity in the liquid supply device 40.

### Third Embodiment

A third embodiment will be described next. The third embodiment differs from the first embodiment in that a plurality of support rollers 49 are provided on a base surface of the support member 43. Only the configurations of the third embodiment that are different from those in the first embodiment will be described hereinafter. Configurations that are the same in the third embodiment and the first embodiment will be given the same reference signs, and descriptions thereof will be omitted.

In the third embodiment, the plurality of support rollers 49 are disposed on a base surface of the support member 43 (the placement surface 43b, in the first embodiment). The support rollers 49 are rollers capable of rotating about a rotation axis that is parallel to the widthwise direction of the support member 43 (the direction in which the rotation shaft 47b of the pressing member 47 extends). The plurality of support rollers 49 are disposed substantially over the entire base surface of the storage space formed in the support member 43. In other words, in the third embodiment, the ink storage container 60 is supported by the support rollers 49 of the support member 43. The diameter of each of the support rollers 49 is smaller than the diameter of the roller portion 47a of the pressing member 47.

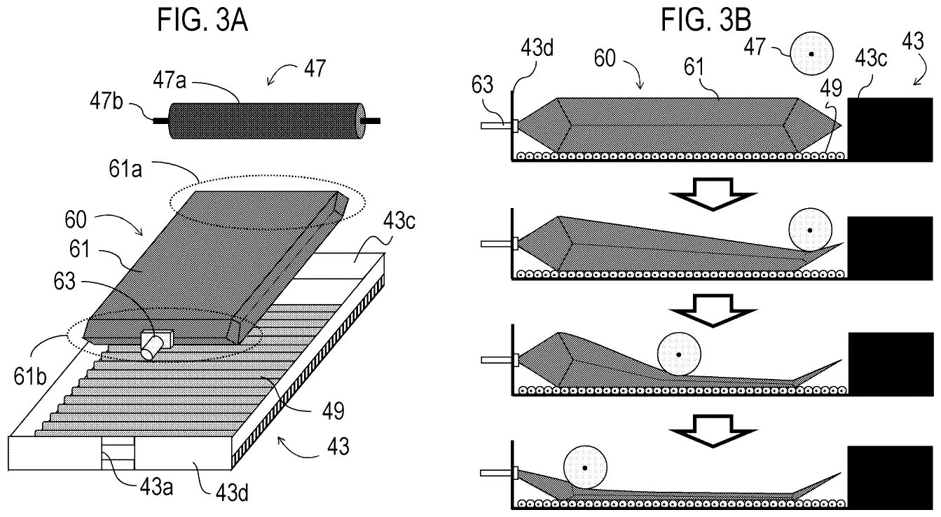

FIGS. 3A and 3B are explanatory diagrams illustrating the support member 43 and the pressing member 47 provided in the liquid supply device 40, as well as the ink storage container 60, according to the third embodiment. FIG. 3A is a perspective view of the pressing member 47, the support member 43, and the ink storage container 60. FIG. 3B is an explanatory diagram illustrating a pressing operation by the pressing member 47 on the ink storage container 60.

Because the support rollers 49 are provided in the support member 43, the ink storage container 60 supported by the support member 43 moves more easily in the longitudinal direction of the support member 43 compared to when the ink storage container 60 is simply placed on a flat surface. This makes the ink storage container 60 move more smoothly when the pressing member 47 moves while pressing the ink storage container 60. This also suppresses situations where the storage portion 61 is pressed such that the pressing member 47 catches on the storage portion 61 and the storage portion 61 is not flattened as intended.

### Fourth Embodiment

A fourth embodiment will be described next. The fourth embodiment is a configuration in which the pressing member 147 according to the second embodiment and the plurality of support rollers 49 according to the third embodiment are combined.

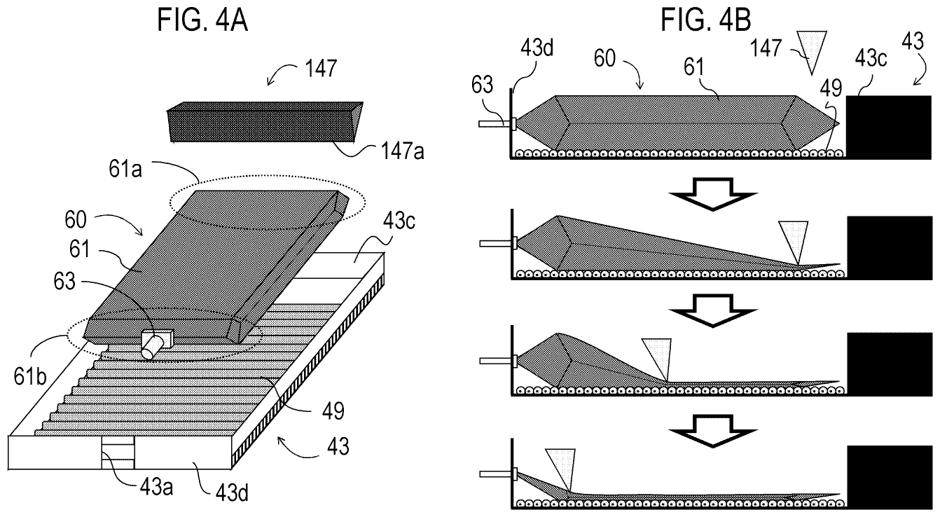

FIGS. 4A and 4B are explanatory diagrams illustrating the support member 43 and a pressing member 147 provided in the liquid supply device 40, as well as the ink storage container 60, according to the fourth embodiment. FIG. 4A is a perspective view of the pressing member 147, the support member 43, and the ink storage container 60. FIG. 4B is an explanatory diagram illustrating a pressing operation by the pressing member 147 on the ink storage container 60.

When the pressing member 147 is in the form of a blade rather than a roller, configuring the support portion that supports the ink storage container 60 with the support rollers 49 makes it particularly easy to achieve the effect of flattening the storage portion 61 as intended.

### Fifth Embodiment

An example in which the pressing member 47 is used to execute an agitation operation for agitating the ink within the ink storage container 60 will be described next as a fifth embodiment. The apparatus configuration in the fifth embodiment is generally the same as that in the third embodiment, and the same reference signs will therefore be used, with descriptions thereof being omitted.

The ink used in the liquid ejection apparatus 100 may contain various additives, including pigments and dyes. Some of these additives settle at the bottom of the ink storage container 60 due to their heavy specific gravity. Accordingly, it is preferable that the ink inside the ink storage container 60 be agitated before the ink supply operations.

However, having the user agitate the ink before attaching the container to the liquid supply device 40 is burdensome for the user, and is also unreliable. Furthermore, if the user attempts to agitate the ink, there is a risk that the ink storage container 60 will be damaged and the ink inside will leak. Furthermore, there are situations where a long time passes after the ink storage container 60 is installed in the liquid supply device 40, leading to a risk that the additives and the like will settle on the bottom surface of the ink storage container again. The ink storage container 60 must therefore be removed and agitated periodically, which places a heavy burden on the user.

Accordingly, the liquid supply device 40 according to the fifth embodiment is configured to be capable of executing an agitation operation for agitating the ink inside the storage portion 61 by moving the ink storage container 60 while being pressed by the pressing member 47. The agitation operation can be executed by the control portion 80 in the same manner as the ink supply operation, and the actions of the pressing member 47 in the agitation operation are controlled by the control portion 80.

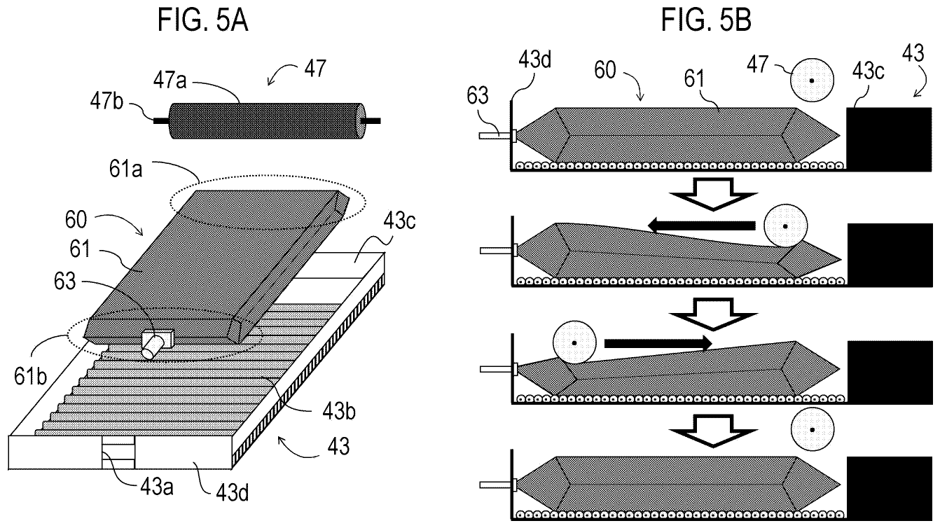

The agitation operation will be described next. FIGS. 5A and 5B are explanatory diagrams illustrating the support member 43 and the pressing member 47 provided in the liquid supply device 40, as well as the ink storage container 60, according to the fifth embodiment. FIG. 5A is a perspective view of the pressing member 47, the support member 43, and the ink storage container 60. FIG. 5B is an explanatory diagram illustrating the agitation operation by the pressing member 47 on the ink storage container 60.

In the agitation operation, the pressing member 47 alternately moves in the direction from the first end portion 43c to the second end portion 43d of the support member 43, and in the direction from the second end portion 43d to the first end portion 43c, repeatedly while pressing the storage portion 61. This causes the ink in the ink storage container 60, which is supported by the plurality of support rollers 49, to vibrate, resulting in an agitation effect within the ink storage container 60.

In the fifth embodiment, the amount by which the pressing member 47 presses the storage portion 61 (the amount by which the pressing member 47 presses into the storage portion 61) is adjustable. The configuration may be such that the position of the pressing member 47 in the direction of gravity can be adjusted freely by, for example, forming the opening 41a in the main body portion 41 to be wider in the direction of gravity, in order to adjust the amount by which the pressing member 47 presses the storage portion 61. Alternatively, the opening 41a in the main body portion 41 may be formed to pass through different paths when the pressing member 47 performs the supply operation and when the pressing member 47 performs the agitation operation. If the pressing member 47 is not configured to be capable of adjusting the amount by which the storage portion 61 is pressed, the configuration may be such that the supply portion 63 or the injection portion 45 is closed such that the ink does not move outside the storage portion 61 anytime other than during the ink supply operations.

In the agitation operation, the amount by which the pressing member 47 presses the storage portion 61 is limited to an amount at which the ink will not move from the storage portion 61 to the injection portion 54. In other words, the amount by which the pressing member 47 presses the storage portion 61 is less than the amount by which the pressing member 47 presses the storage portion 61 in the supply operation.

The pressing member 47 is attached to the main body portion 41 of the liquid supply device 40, which is integrated with the liquid ejection apparatus 100. Accordingly, for example, the agitation operation can be set to be performed periodically according to a timer provided in the liquid ejection apparatus 100. It is also possible to set the agitation operation to be executable as appropriate according to the use method, the type of the ink, and the like, when ink is supplied before printing, when the support member 43 is set in the main body portion 41, when the ink supply operations are suspended (the pressing member 47 is in the position illustrated in FIG. 7C), and the like.

After the agitation operation is completed, the pressing member 47 is controlled to return to the position where it was before the agitation operation was started. Then, when the ink supply operations are started, the pressing member 47 moves from the first end portion 43c toward the second end portion 43d, and the liquid supply device 40 supplies the ink from the ink storage container 60 to the liquid ejection apparatus 100.

According to the present disclosure, a liquid supply device capable of efficiently supplying ink from within a liquid storage container can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177670, filed Oct. 10, 2024, which is hereby incorporated by reference herein in its entirety.

What is claimed is:

1. A liquid supply device configured to supply a liquid from a liquid storage container, the liquid storage container having a storage portion that is flexible and that stores a liquid inside and a supply portion configured to supply the liquid stored inside the storage portion, the liquid supply device comprising:
a support portion supporting the liquid storage container, the support portion having a first end portion, a second end portion on a side opposite from the first end portion, and a placement surface on which the storage portion can be placed;
an injection portion to which the supply portion is connected and into which the liquid stored in the storage portion is injected through the supply portion, the injection portion being provided in the second end portion of the support portion;
a pressing member configured to press the storage portion of the liquid storage container supported by the support portion; and
a control portion configured to execute a supply operation for supplying liquid by controlling an action of the pressing member,
wherein in a state in which the supply portion is connected to the injection portion, the storage portion is placed on the placement surface, and
wherein in the supply operation, the control portion causes the pressing member to move in a direction from the first end portion toward the second end portion in a state in which the pressing member is pressing the storage portion.

2. The liquid supply device according to claim 1,
wherein the pressing member is configured to be capable of moving among (i) a first pressing position in which the pressing member presses an end portion on the first end portion side of the liquid storage container supported by the support portion, (ii) a second pressing position in which the pressing member presses an end portion on the second end portion side of the liquid storage container supported by the support portion, and (iii) a retracted position in which the pressing member is retracted from the liquid storage container supported by the support portion.

3. The liquid supply device according to claim 1,
wherein the pressing member is a roller configured to be capable of rotating, and in the supply operation, the pressing member moves in the direction from the first end portion toward the second end portion while pressing the storage portion and while rotating.

4. The liquid supply device according to claim 1,
wherein the pressing member is a blade having a tip portion extending in a direction that intersects with the direction from the first end portion toward the second end portion, and
wherein in the supply operation, the control portion causes the blade to move in a direction from the second end portion toward the first end portion while pressing the storage portion with the tip portion of the blade.

5. The liquid supply device according to claim 1,
wherein the support portion has a plurality of support rollers that are capable of rotating and that support the storage portion from below in a state in which the supply portion is connected to the injection portion.

6. The liquid supply device according to claim 5,
wherein the pressing member is a roller configured to be capable of rotating, and
wherein a diameter of the support roller is smaller than a diameter of the pressing member.

7. The liquid supply device according to claim 1,
wherein the control portion is capable of executing an agitation operation that agitates the liquid stored in the storage portion by causing the pressing member to move in a state in which the pressing member is pressing the storage portion.

8. The liquid supply device according to claim 7,
wherein an amount by which the pressing member presses the storage portion in the agitation operation is less than an amount by which the pressing member presses the storage portion in the supply operation.

9. The liquid supply device according to claim 1,
wherein the pressing member is formed of rubber or plastic.

10. A liquid ejection apparatus comprising:
a liquid supply device configured to supply a liquid from a liquid storage container, the liquid storage container having a storage portion that is flexible and that stores a liquid inside and a supply portion for supplying the liquid stored inside the storage portion, the liquid supply device including:
a support portion supporting the liquid storage container, the support portion having a first end portion, a second end portion on a side opposite from the first end portion, and a placement surface on which the storage portion can be placed;
an injection portion to which the supply portion is connected and into which the liquid stored in the storage portion is injected through the supply portion, the injection portion being provided in the second end portion of the support portion;
a pressing member configured to press the storage portion of the liquid storage container supported by the support portion; and
a control portion configured to execute a supply operation for supplying liquid by controlling an action of the pressing member,
a conveyance portion configured to convey a recording medium; and
a liquid ejection head configured to eject the liquid supplied from the liquid supply device to the recording medium conveyed by the conveyance portion,
wherein in a state in which the supply portion is connected to the injection portion, the storage portion is placed on the placement surface, and
wherein in the supply operation, the control portion causes the pressing member to move in a direction from the first end portion toward the second end portion in a state in which the pressing member is pressing the storage portion.
